(19) United States
(12) Patent Application Publication
(10) Pub. No.: US 2022/0334793 A1
(43) Pub. Date: Oct. 20, 2022

(54) AUDIO SYSTEM FOR HUNTING AND METHOD OF USE THEREOF

(71) Applicant: Logan Mariano, Phoenix, AZ (US)

(72) Inventor: Logan Mariano, Phoenix, AZ (US)

(21) Appl. No.: 17/722,044

(22) Filed: Apr. 15, 2022

Related U.S. Application Data
(60) Provisional application No. 63/175,079, filed on Apr. 15, 2021.

(51) Int. Cl. G06F 3/16; H04R 1/40; H04R 3/12; A01M 31/06

(52) U.S. Cl. CPC G06F 3/165; H04R 1/403; H04R 3/12; A01M 31/06; H04R 2420/07

(57) ABSTRACT

A system for obtaining the attention of a game animal includes two speakers and a control unit. The two speakers may be placed a distance apart from one another and a hunter. The control unit is usable by the hunter to separately and independently control the speaker assemblies remotely, thereby providing the hunter with the ability to create sounds from different directions or locations to obtain a better shot at the game animal.

### CROSS-REFERENCE TO RELATED APPLICATION

This application claims the benefit of U.S. Provisional Application No. 63/175,079, filed Apr. 15, 2021, and which is hereby incorporated by reference in its entirety.

### TECHNICAL FIELD

This disclosure relates to audio devices for use during hunting game animals.

### BACKGROUND OF THE INVENTION

Game animals are often alert and vigilant. Hunters must take extra care to avoid detection. Typically, hunters avoid detection by employing camouflage, scent masking, etc. However, movement by the hunter while aiming a bow or a firearm could startle a game animal and cause the game animal to flee before the hunter is able to complete aiming and firing.

### SUMMARY

A system for distracting game animals is provided. The system includes a first speaker assembly having a first speaker, and a second speaker assembly having a second speaker. The system further includes a control unit that is in wireless communication with the first speaker assembly and the second speaker assembly. The system is configured such that the control unit wirelessly controls the first speaker assembly and the second speaker assembly separately and independently. Thus, a hunter is provided with the ability to produce sounds in at least two separate locations distant from the hunter.

The system provided herein enables a hunter to either draw a game animal's attention away from the hunter, thereby giving the hunter enough time to draw the bow without being seen, or to stop a walking game animal, thereby giving the hunter an ethical shot. The use of two speakers, independently and separately controllable via a single control unit, enables the hunter to draw the attention of the animal in two different directions, which is beneficial because of the unpredictable direction of travel of the game animal.

In one embodiment, the control unit is mountable to a weapon such as a firearm or bow. The control unit may be divided into two separate portions operatively interconnected with a cable for transmitting power and signals therebetween thereby to evenly distribute the weight and volume of the control unit across the weapon.

A corresponding method of use is also provided.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a game distraction system, including first and second speaker assemblies and a control unit;

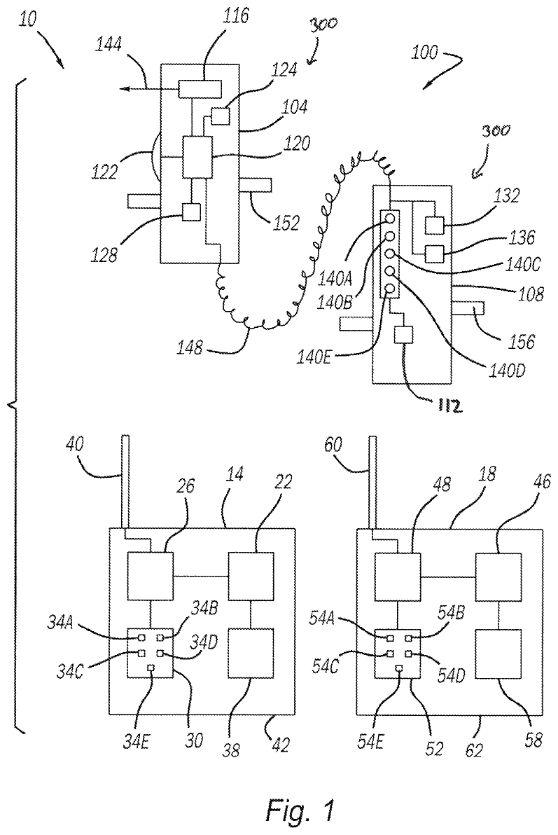

FIG. 2 is a schematic, side view of the control unit of FIG. 1 mounted to a bow;

FIG. 3 is a schematic, side view of the control unit of FIG. 1 and a portion of the bow;

FIG. 4 is a schematic, top view of the system of FIG. 1 in one example of use during hunting.

### DETAILED DESCRIPTION

Referring to the Figures, wherein like reference numbers refer to like components throughout, a game distraction system 10 includes a first speaker assembly 14 and a second speaker assembly 18. The first speaker assembly 14 includes a first speaker 22, a first processor 26, a first data storage medium 30 storing a plurality of data files 34A-34E, a first power source 38, and a first antenna 40. The first speaker assembly 14 in the embodiment depicted includes a housing 42 in which all components except the antenna 40 are housed.

The first processor 26 is operatively connected to the first data storage medium 30 to selectively obtain data files 34A-34E therefrom. Each data file 34A-34E includes data that enables the processor 26 to cause the speaker 22 to produce a respective sound. For example, data file 34A may instruct processor 26 to cause speaker 22 to generate a chime sound, data file 34B may instruct processor 26 to cause speaker 22 to generate a whistle sound, etc. Thus, each data file 34A-34E includes data necessary to generate a different sound via speaker 22.

The antenna 40 is configured to receive wireless signals and convert the wireless signals to electronic signals. The antenna 40 is operatively connected to the processor 26 such that the electronic signals are received by the processor 26. The power source 38, such as a rechargeable battery, is operatively connected to the speaker 22 and the processor 26 to supply electrical energy thereto.

The second speaker assembly 18 is substantially similar to the first speaker assembly 14, and includes a second speaker 46, a second processor 48, a second data storage medium 52 storing a plurality of data files 54A-54E, a second power source 58, and a second antenna 60. The second speaker assembly 18 in the embodiment depicted includes a housing 62 in which all components except the antenna 60 are housed.

The second processor 48 is operatively connected to the second data storage medium 52 to selectively obtain data files 54A-54E therefrom. Each data file 54A-54E includes data that enables the processor 48 to cause the speaker 46 to produce a respective sound. For example, data file 54A may instruct processor 48 to cause speaker 46 to generate a chime sound, data file 54B may instruct processor 48 to cause speaker 46 to generate a whistle sound, etc. Thus, each data file 54A-54E includes data necessary to generate a different sound via speaker 46.

The antenna 60 is configured to receive wireless signals and convert the wireless signals to electronic signals. The antenna 60 is operatively connected to the processor 48 such that the electronic signals are received by the processor 48. The power source 58, such as a rechargeable battery, is operatively connected to the speaker 46 and the processor 48 to supply electrical energy thereto.

The system 10 also includes a control unit 100. The control unit 100 includes a first housing 104 and a second housing 108. In the embodiment depicted, the control unit 100 also includes a power source 112, a wireless signal transmitter 116, a third processor 120, and a plurality of input devices. The input devices include a volume control c140E.

The control unit 100 is usable by a hunter to individually control the speaker assemblies 14, 18. More specifically, each of the input devices is operatively connected to the third processor 120 and configured to send signals thereto indicative of the user's desired actions for the speaker assemblies 14, 18. The third processor 120 is operatively connected to the transmitter 116 and configured to transmit wireless signals 144 in response to the status of the input devices. The antennas 40, 60 receive the wireless signals 144 and the processors 26, 48 are programmed to respond to the signals 144 as described below.

The various components of the control unit 100 are distributed between the first and second housings 104, 108. In the embodiment depicted, the transmitter 116, processor 120, buttons 124, 128, and volume control 122 are mounted to and/or housed within the first housing 104; buttons 132, 136, 140A-140E and power source 112 are mounted to and/or housed within the second housing 108. It should be noted that the various components of the control unit 100 may be distributed between the two housings in any manner within the scope of the claimed invention.

The control unit 100 includes a flexible, conductive, insulated cable 148 for transmitting electrical energy and signals between the components of the first housing 104 and the components of the second housing 108 while also permitting the housings 104, 108 to move relative to one another. In the embodiment depicted, the cable 148 is coiled so that it is elastically variable in length.

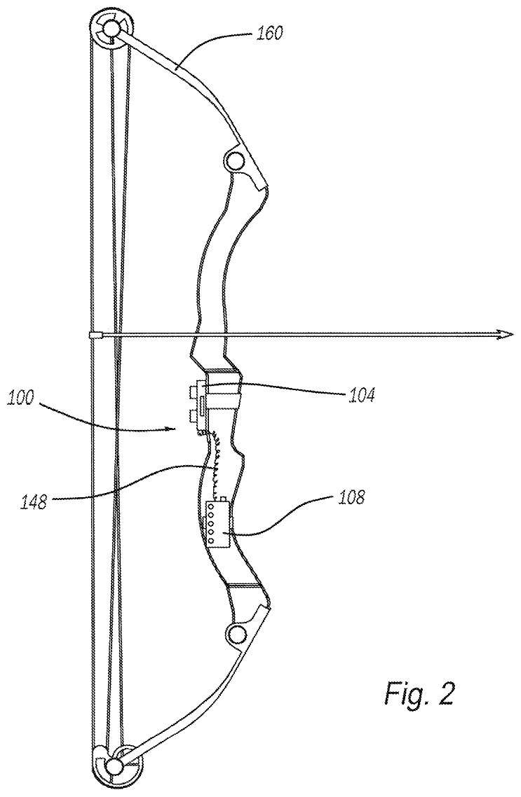

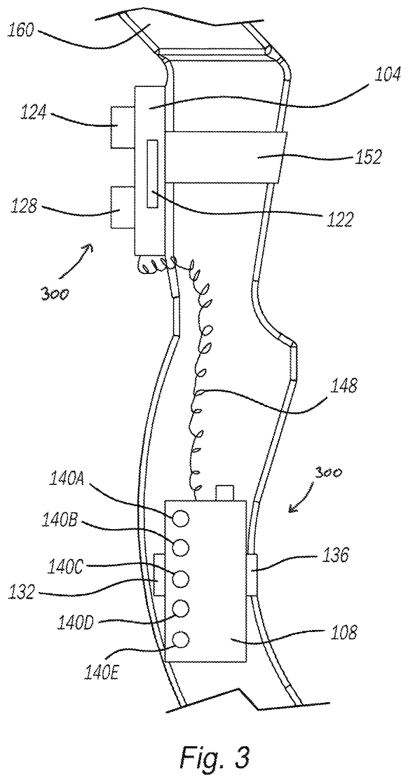

The control unit 100 includes a first fastening element 152 operatively connected to the first housing 104 and a second fastening element 156 operatively connected to the second housing 108. The fastening elements 152, 156 in the embodiment depicted are straps with hook and loop fasteners. Each fastening element 152, 156 is configured to selectively mount its respective housing 104, 108 to a weapon, such as a bow 160, as shown in FIGS. 2 and 3.

Referring specifically to FIGS. 2 and 3, the distribution of the components of the control unit 100 between the two housings 104, 108 enables the volume and mass of the control unit 100 to be distributed along the length of the bow 160, thereby avoiding a single large, bulky, and heavy mass attached in a single housing, which could negatively affect the ability of the hunter to accurately use the bow 160. The flexible and elastically extendible cable 148 provides flexibility to the user in determining where to mount the housings 104, 108 relative to each other and to the bow 160; the length of the cable 148 will automatically adjust to the distance between the housings 104, 108.

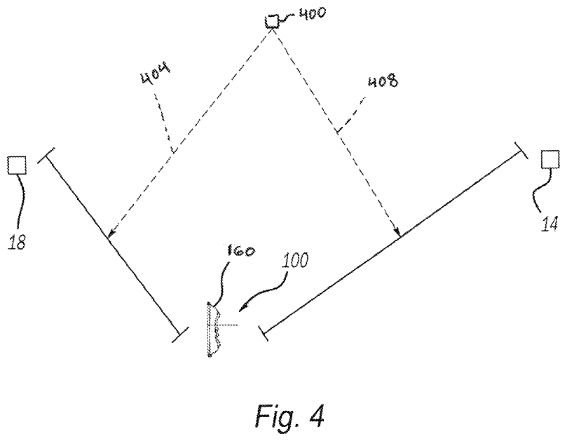

FIG. 4 schematically depicts a sample use of the system 10. A hunter may place each speaker assembly 14, 18 approximately 40-50 yards away from the hunter's location during hunting as shown, thereby providing the hunter with various distraction sound options for various paths a game animal may take. The control unit 100 controls the speaker assemblies 14, 18 independently of one another, even though both speaker assemblies 14, 18 receive the wireless signals. For example, signals intended only for the first speaker assembly 14 may be transmitted at a different frequency than signals intended for the second speaker assembly 18, or, if digital signals are used, the wireless signals may include instructions for which of the speaker assemblies 14, 18 will respond.

The user may select which of the preprogrammed sounds each speaker assembly 14, 18 produces. More specifically, in the embodiment depicted the user selects which sound is produced by the first speaker assembly 14 by depressing the first speaker programming button 132 and then selecting one of the sound selection buttons 140A-E. Each of the sound selection buttons 140A-140E corresponds to a respective one of the sounds produced by files 34A-E. The processor 120 receives the signal from the depressed button 140A-140E, which causes transmitter 116 to transmit a wireless signal that is received by the first processor 26 via antenna 40, which in turn instructs the first processor 26 to produce the sound, when an actuation signal is transmitted, described by the file 34A-E that corresponds to the button 140A-E depressed.

Similarly, the user selects which sound is produced by the second speaker assembly 18 by depressing the second speaker programming button 136 and then selecting one of the sound selection buttons 140A-E. Each of the sound selection buttons 140A-140E corresponds to a respective one of the sounds produced by files 54A-E. The processor 120 receives the signal from the depressed button 140A-140E, which causes transmitter 116 to transmit a wireless signal that is received by the second processor 48 via antenna 60 and instructs the second processor 48 to produce the sound, when an actuation signal is transmitted, described by the file 54A-E that corresponds to the button 140A-E depressed.

The user causes the first speaker 22 to generate the sound from the selected data file 34A-E by depressing the first speaker actuation button 124. Depressing the first speaker actuation button 124 generates an actuation signal to which the first speaker assembly 14 responds by producing the sound, and to which the second speaker assembly 18 does not respond.

Similarly, the user causes the second speaker 46 to generate the sound from the selected data file 54A-E by depressing the second speaker actuation button 128. Depressing the second speaker actuation button 128 generates an actuation signal to which the second speaker assembly 18 responds by producing the sound, and to which the first speaker assembly 14 does not respond. The volume of both speaker assemblies is adjustable with the volume control 122.

The system 10 enables a hunter to either draw a game animal's attention away from the hunter, thereby giving the hunter enough time to draw the bow without being seen, or to stop a walking game animal, thereby giving the hunter an ethical shot. The use of two speakers, independently and separately controllable via a single control unit enables the hunter to draw the attention of the animal in two different directions, which is beneficial because of the unpredictable direction of travel of the game animal. The system 10 provided herein is also very simple to use and uses digital sound files that are preprogrammed.

It should be noted that, within the scope of the claimed invention, the sound files 34A-34E, 54A-54A may include traditional animal call sounds, i.e., sounds that attract animals, in addition to or instead of sounds that merely distract an animal such as the chime and whistle sounds. It should also be noted that each of components 100, 14, 18 may include a power button or switch to turn the device on and off as understood by those skilled in the art.

As used herein, a “wireless” signal is any signal that is transmitted via electromagnetic waves, and may include radio signals including, but not limited to, such technologies as Bluetooth, WiFi, etc.

As used herein, a “processor” or a “controller” may be any apparatus or combination of apparatuses that perform the functions described herein, including but not limited to microprocessors. As used herein, “controller” and “processor” are used interchangeably.

The input devices 122, 124, 128, 132, 136, 140A-E together form a user interface 300 through which a user interacts with the control unit 100. It should be noted that any user interface configuration may be employed within the scope of the claimed invention. For example, and without limitation, the buttons 124, 128 may be replaced with a three-position rocker switch, or all input devices may be replaced by a touch-screen within the scope of the claimed invention.

Thus, the system 10 includes a first speaker assembly 14 having a first speaker 22, a second speaker assembly 18 having a second speaker 46, and a control unit 100. The control unit 100 is configured to wirelessly control the first speaker assembly 14 and the second speaker assembly 18, and has a user interface 300 that is manipulable by a user between a first state, a second state, and a third state.

The control unit 100 is configured such that neither the first speaker 22 nor the second speaker 46 generates sound when the user interface 300 is in the first state (e.g., when neither button 124, 128 is depressed). The control unit 100 is configured to cause the first speaker 22, and not the second speaker 46, to generate sound in response to the user interface 300 being in the second state (e.g., button 124 being depressed while button 128 is not depressed). The control unit 100 is configured to cause the second speaker 46, and not the first speaker 22, to generate sound in response to the user interface 300 being in the third state (e.g., button 124 not being depressed while button 128 is depressed).

The control unit 100 is configured to selectively cause the first and second speakers to generate sound by transmitting the wireless signals 144 via the transmitter 116 to the first and second antennas 40, 60. More specifically, in the embodiment depicted, the processor 120 is operatively connected to the buttons 124, 128 is operatively connected to all of the input devices in a manner understood by those skilled in the art so that the processor 120 monitors the states of the button 124, 128 and is programmed and configured to cause the transmitter 116 to transmit the signals 144 to the speaker assemblies 14, 18 to which the speakers assemblies 14, 18 are responsive to produce the effects described.

The system 10 includes at least one controller 26, 48, 120 operatively connected to the first speaker 22 and the second speaker 46 and configured to control the sound output of the first and second speaker. As used herein, two components being “operatively connected” includes, but is not limited to, being operatively connected via wireless communication.

At least one data storage medium 30, 52 has a plurality of data files 34A-E, 54A-E stored thereon, each of the data files having data describing a respective set of sound attributes, such as duration, frequency, etc. In one embodiment, the data files 34A-E, 54A-E are digital sound files such as, but not limited to, Waveform Audio File Format (.wav) or MP3.

The at least one controller 26, 48, 120 is operatively connected to the user interface 300 such that the user interface 300 is manipulable by a user to select one of the plurality of data files 34A-E as a first assigned data file and to select another of the plurality of data files 54A-E as a second assigned data file and to communicate the selection of the first and second assigned data files to said at least one controller 26, 48, 120.

The at least one controller 26, 48, 120 is configured to cause the first speaker 22, and not the second speaker 46, to generate sound having the attributes of the first assigned data file in response to the user interface being in the second state, and the at least one controller 26, 48, 120 is configured to cause the second speaker 46, and not the first speaker 22, to generate sound having the attributes of the second assigned data file in response to the user interface being in the third state.

Referring specifically to FIG. 4, a method of using the system 10 includes placing the first speaker assembly 14 in a first location, as shown in FIG. 4, placing a second speaker assembly 18 in a second location as shown in FIG. 4, and taking a hunting weapon, e.g., the bow 160, and the control unit 100 to a third location as shown in FIG. 4. The method may also include attaching the control unit to the hunting weapon as shown in FIGS. 2-4. The speaker assemblies 14, 18 may be placed on the ground, on a rock, attached to a tree or post, etc. The speaker assemblies 14, 18 may include fasteners such as straps to connect to a tree or other object. They may also include stands for supporting above the ground.

The hunter will be adjacent the bow 160 in FIG. 4. In one method of use, the distance between each of the bow 160, the first speaker assembly 14, and the second speaker assembly 18 will be 30 yards, though the control unit 100 is effective in controlling the first and second speaker assemblies 14, 18 from at least 50 yards.

When a game animal 400 is in the vicinity of the hunter, the game animal may take various travel paths 404, 408. The hunter may use the user interface 300 to select cause either speaker assembly 14, 18 to create a sound; the speaker selected by the hunter will depend on the location and/or travel direction of the game animal. The hunter may also select the desired sound from the sound files of each speaker assembly.

While the best modes for carrying out the disclosure have been described in detail, those familiar with the art to which this disclosure relates will recognize various alternative designs and embodiments for practicing the disclosure within the scope of the appended claims.

1. A system for engaging game animals, the system comprising:
a first speaker assembly having a first speaker;
a second speaker assembly having a second speaker;
a control unit configured to wirelessly control the first speaker assembly and the second speaker assembly, and having a user interface that is manipulable by a user between a first state, a second state, and a third state;
wherein the control unit is configured such that neither the first speaker nor the second speaker generates sound when the user interface is in the first state;
wherein the control unit is configured to cause the first speaker, and not the second speaker, to generate sound in response to the user interface being in the second state;
wherein the control unit is configured to cause the second speaker, and not the first speaker, to generate sound in response to the user interface being in the third state.

2. The system of claim 1, wherein the control unit is configured to wirelessly control the first and second assemblies from a distance of at least fifty yards.

3. The system of claim 1, wherein the control unit includes a transmitter configured to transmit wireless signals;
wherein the first speaker assembly includes an antenna configured to receive the wireless signals;
wherein the second speaker assembly includes a second antenna configured to receive the wireless signals;
wherein the control unit is configured to selectively cause the first and second speakers to generate sound by transmitting the wireless signals via the transmitter to the first and second antennas.

4. The system of claim 3, further comprising at least one controller operatively connected to the first speaker and the second speaker and configured to control the sound output of the first and second speaker;
at least one data storage medium having a plurality of data files stored thereon, each of said data files having data describing a respective set of sound attributes;
said at least one controller being operatively connected to the user interface such that the user interface is manipulable by a user to select one of the plurality of data files as a first assigned data file and to select another of the plurality of data files as a second assigned data file and to communicate the selection of the first and second assigned data files to said at least one controller;
wherein said at least one controller is configured to cause the first speaker, and not the second speaker, to generate sound having the attributes of the first assigned data file in response to the user interface being in the second state;
wherein said at least one controller is configured to cause the second speaker, and not the first speaker, to generate sound having the attributes of the second assigned data file in response to the user interface being in the third state.

5. The system of claim 4, wherein the control unit includes a battery operatively connected to the transmitter, the user interface, and said at least one controller;
wherein the control unit includes a first housing and a second housing;
wherein at least one of said battery, transmitter, user interface, and controller is mounted to the first housing;
wherein at least one of said battery, transmitter, user interface, and controller is mounted to the second housing;
wherein the control unit further includes a flexible, conductive, insulated cable operatively interconnecting the first and second housings such that the cable provides a conductive path for transmitting electrical energy and signals between the first housing and the second housing while also permitting the housings 104, 108 to move relative to one another.

6. A method comprising:
placing a first speaker in a first location;
placing a second speaker in a second location; and
taking a hunting weapon and a control unit to a third location;
said control unit having a user interface with which a user may cause either of the first and second speaker to generate a sound.

7. The method of claim 6, further comprising manipulating the user interface to cause one of the first and second speakers, and not the other of the first and second speakers, to generate a sound.

8. The method of claim 7, wherein said manipulating the user interface to cause one of the first and second speakers, and not the other of the first and second speakers, to generate a sound includes causing the control unit to transmit wireless signals to which one of the first and second speakers is responsive.

9. The method of claim 6, further comprising selecting a sound for one of the first and second speakers to generate, and communicating the selected sound to the control unit via the user interface; and
manipulating the user interface to cause one of the first and second speakers, and not the other of the first and second speakers, to generate the selected sound.

10. The method of claim 6, wherein the first location is at least 30 yards from the third location;
wherein the second location is at least 30 yards from the third location; and
wherein the first location is at least 30 yards from the second location.

11. The method of claim 6, further comprising attaching the control unit to the hunting weapon.
